(19) United States
(12) Patent Application Publication
(10) Pub. No.: US 2006/0146018 A1
(43) Pub. Date: Jul. 6, 2006

(54) Joystick with tactile feedback

(76) Inventors: Theodore R. Arneson, Ivanhoe, IL (US); Roger W. Ady, Chicago, IL (US)

Correspondence Address: MOTOROLA INC, 600 NORTH US HIGHWAY 45, ROOM AS437, LIBERTYVILLE, IL, 60048-5343, US

(21) Appl. No.: 11/028,415

(22) Filed: Jan. 4, 2005

(51) Int. Cl. G09G 5/08

(52) U.S. Cl. 345/161

(57) ABSTRACT

An electronic device has a tactile joystick with a force sensing resistive layer (120) in an XY plane; a flexible mould (115) surrounding at least one portion of the force sensing resistive layer (120); a plunger (190) coupled to the flexible mould (115), mounted orthogonal to the XY plane; and, a tactile dome (110) disposed adjacent to one of a top surface (135) and a bottom surface (133) of the plunger (190). Further, a method of implementing a function using a tactile device includes actuating a tactile dome by applying a force (605); determining a distribution of the force in a plurality of sections in a force sensing resistive layer (610); and implementing the function (630, 635).

### FIELD OF INVENTION

The present invention relates to an electronic device with a joystick for navigation and select functions.

### BACKGROUND OF THE INVENTION

With the progress of technology, electronic devices are becoming increasingly advanced and capable of performing a variety of tasks. A user of an electronic device expects additional and more complex functionalities to be provided in the electronic device while keeping the device compact. As the functionalities available in the electronic devices increase, the ability to navigate through and access the various options and functions available to the user becomes increasingly important. A joystick is one solution enabling users to navigate easily through and access the various functionalities available through electronic devices such as video game consoles or mobile phones.

Present day joysticks often use separate buttons to implement a “select” function and for controlling the movement of an onscreen cursor. In the case of gaming joysticks, the navigation on the screen is done using a knob and often a separate button is used to “select”. The use of separate buttons can be extremely inconvenient for users. Generally, keypads of electronic devices such as mobile phones provide tactile feedback to users when the keys on the keypad are depressed thus confirming the selection. Joysticks, however, often lack this crisp tactile feedback.

Thus, there is a need for a joystick with tactile feedback that facilitates onscreen cursor navigation through 360 degrees of movement in an XY plane. The joystick movement performed by the user should be replicated accurately by the onscreen pointer and also provide the user with a crisp tactile feedback when the user performs a selection.

### BRIEF DESCRIPTION OF DIAGRAMS

The accompanying figures together with the detailed description below are incorporated in and form part of the specification, serve to further illustrate various embodiments and to explain various principles and advantages all in accordance with the present invention.

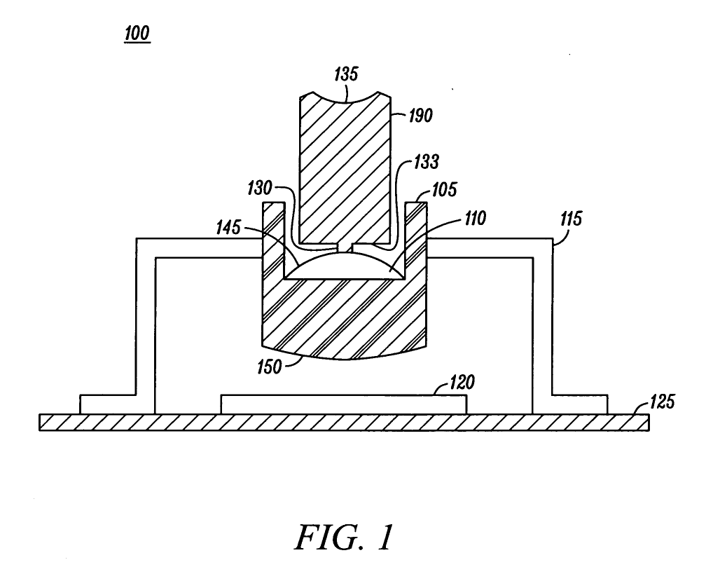

FIG. 1 illustrates a joystick pursuant to an embodiment of the invention.

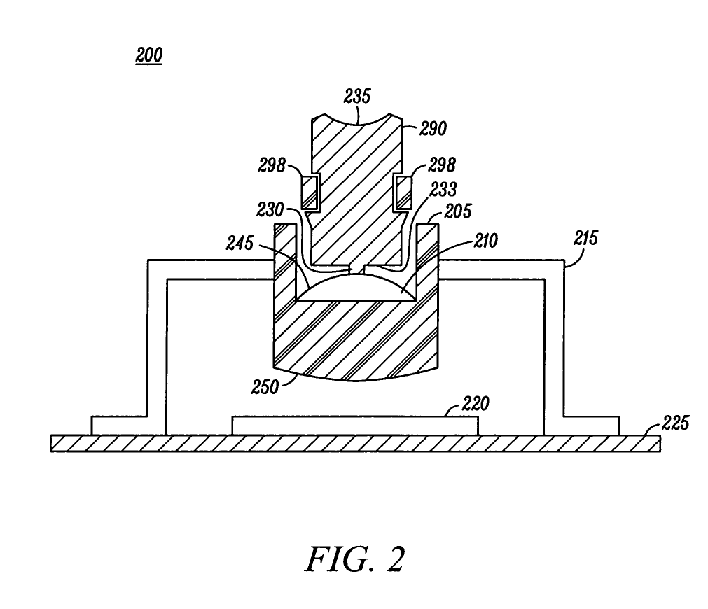

FIG. 2 illustrates a joystick with snap locks on a rigid retainer pursuant to an embodiment of the invention.

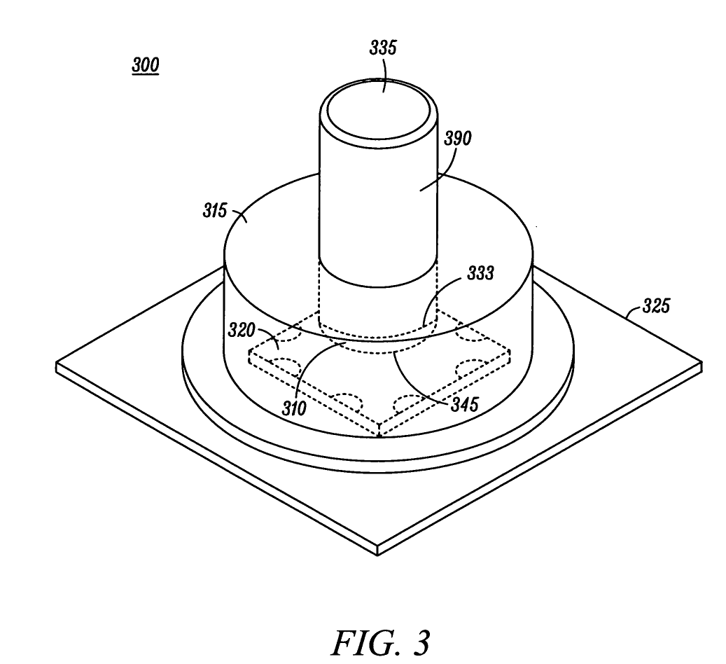

FIG. 3 illustrates a perspective view of a joystick pursuant to an embodiment of the invention.

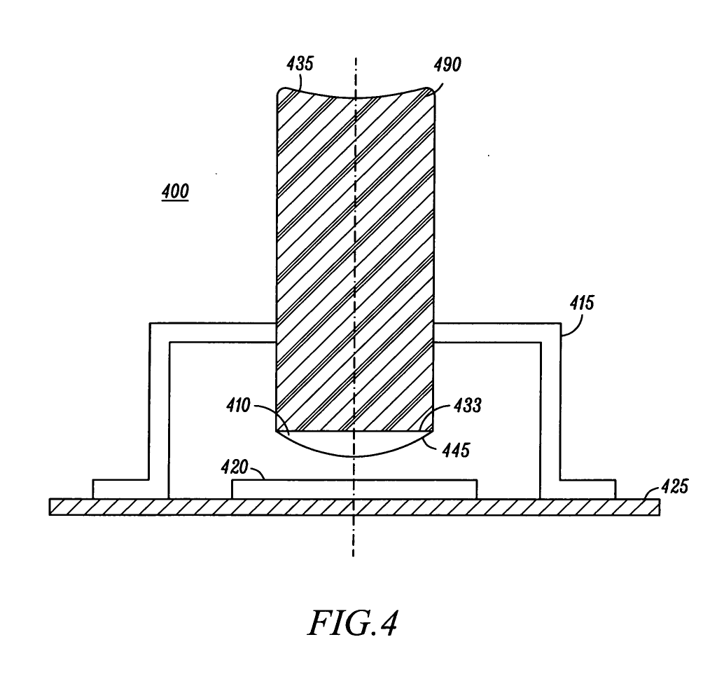

FIG. 4 illustrates a joystick pursuant to another embodiment of the invention.

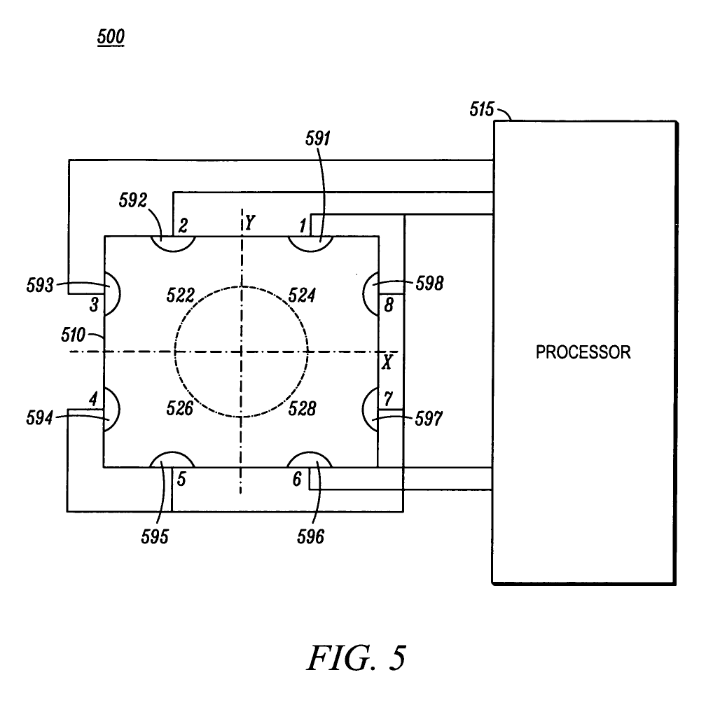

FIG. 5 illustrates an embodiment depicting a force sensing resistive layer.

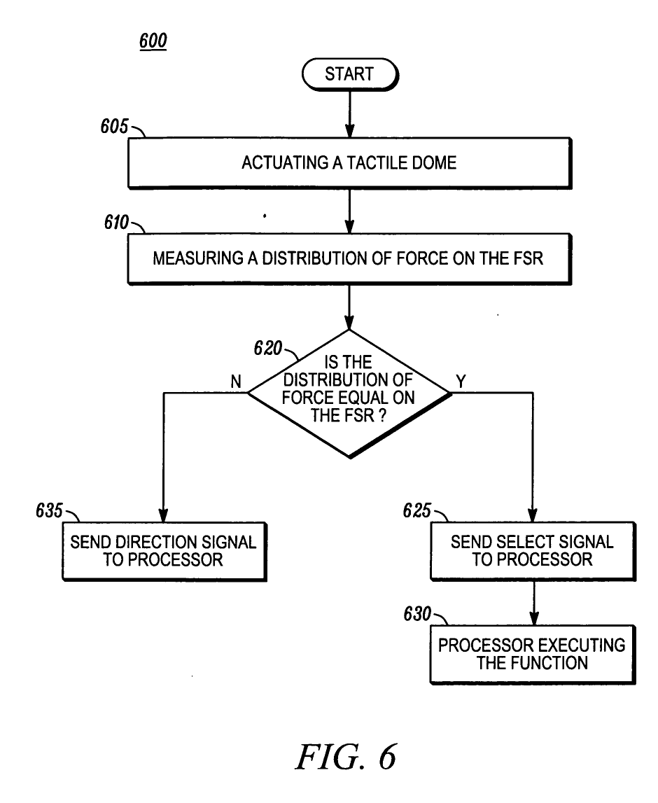

FIG. 6 is a flowchart depicting the functions implemented by the joystick pursuant to an embodiment of the invention.

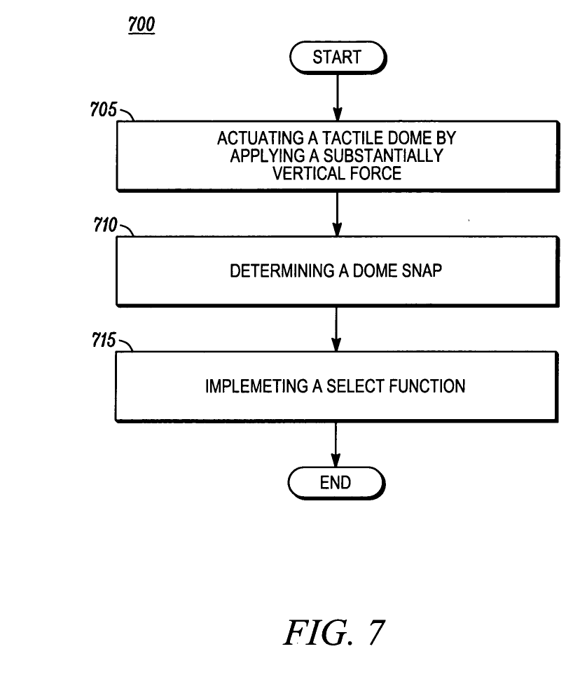

FIG. 7 is a flowchart depicting the implementation of a “select” function implemented by a joystick pursuant to an embodiment.

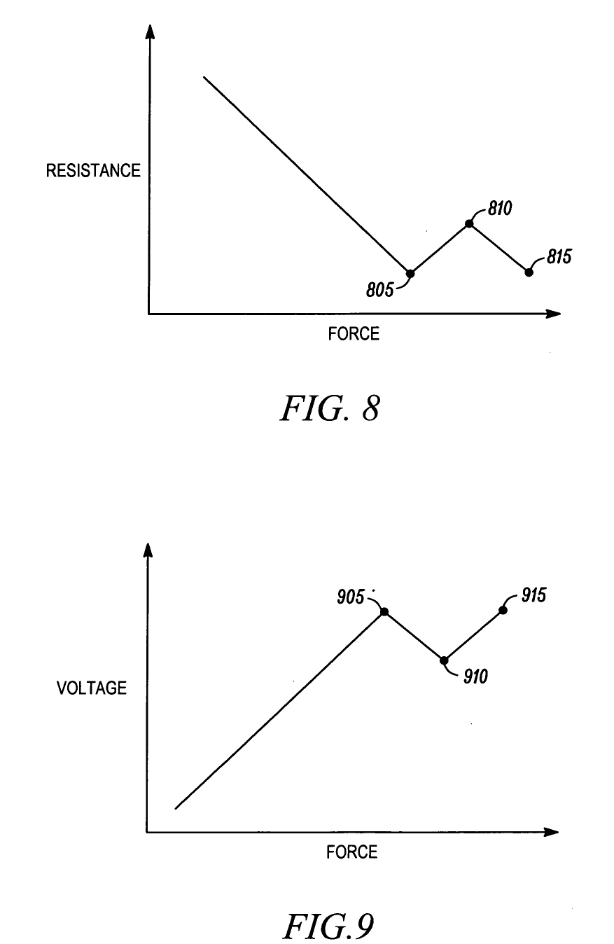

FIG. 8 shows a force versus resistance graph as used in an embodiment of the present invention.

FIG. 9 shows a force versus voltage graph as used in an embodiment of the present invention.

### DETAILED DESCRIPTION

The present invention may be embodied in several forms and manners. The description provided below and the drawings show exemplary embodiments of the invention. Those of skill in the art will appreciate that the invention may be embodied in other forms and manners not shown below. The invention shall have the full scope of the claims and is not to be limited by the embodiments shown below.

An electronic device has a joystick that provides onscreen cursor navigation control and also tactile feedback while performing a “select” function. The electronic device may be implemented as one of several devices such as mobile telephone devices, remote controllers, game controllers, personal digital assistants (PDAs), laptop computers and other electronic devices. Depending on the implementation, the joystick is capable of movement in all directions in the XY plane (horizontal movement) as well as the Z direction (vertical movement).

The joystick as described provides several advantages. One advantage is the tactile feedback that the user receives when a tactile dome in the joystick is pressed. When the user makes a selection on the electronic device using the joystick, he experiences tactile feedback confirming the selection. The tactile dome, on being pressed beyond a critical point, produces a snap that is responsible for providing crisp tactile feedback to the user of the joystick.

The design of the joystick enables the integration of a “select” function as well as navigation functions without the use of additional buttons. A “select” function is activated when the user forces the joystick in a Z direction, which performs a selection of an onscreen utility, an onscreen hyperlink, or a non-screen function such as “fire” in a video game. The navigation function is activated when the user moves the joystick in an XY plane, which moves an onscreen cursor to a specific location on a computing device, scrolls a display, or the like.

In the embodiments shown, the tactile joystick has a force sensing resistive layer that is configured to receive an external force from an actuating device. The force sensing resistive layer has a plurality of sensing elements that receive the external force. The force sensing resistive layer sends a “select” signal to a processor when the distribution of the forces is substantially equal in all sensing elements of the force sensing resistive layer. Alternatively, a tactile dome snap produces a change in resistance and voltage, which can also be identified as a “select” function. In the event of the force being greater in a particular sensing element (with or without a dome snap), the force sensing resistive layer sends a “Direction” signal to the processor to enable movement in the direction of the external force experienced by the particular sensing element.

FIG. 1 illustrates a joystick pursuant to an embodiment of the invention. In the particular embodiment illustrated in FIG. 1, the joystick 100 is a navigation device that can be used to move an onscreen cursor. For example, in the case of mobile phones, the user can use the joystick to select an icon on the screen or scroll through the various options available on the screen. Typically, the user may scroll up, down, left or right and then make a selection of the software application he wishes to use on the mobile phone. In other situations, the joystick can control a cursor on a webpage.

In one embodiment, the joystick 100 includes a force sensing resistive layer 120 in an XY plane, a flexible mould 115 surrounding at least a portion of the force sensing resistive layer 120, a plunger 190 mounted orthogonal to the XY plane, a rigid retainer 105 coupled to the plunger 190 and the flexible mould 115, and a tactile dome 110 disposed between the rigid retainer 105 and the bottom surface 133 of the plunger 190. The entire apparatus as depicted above is mounted on a base 125 such as a Printed Circuit Board (“PCB”) in the electronic device.

The plunger 190 can be a type of knob with a top surface 135 designed to receive a human finger for applying an external force. The plunger 190 is partially enclosed within the rigid retainer 105 and is in contact with the tactile dome 110 such that the tactile dome 110, in the absence of the external force on the plunger 190, is in a relaxed state. The tactile dome 110 is enclosed between the bottom surface 133 of the plunger 190 and the rigid retainer 105. The bottom surface 133 of the plunger has a protrusion 130 to provide force to a convex surface 145 of the tactile dome 110 when the plunger 190 is depressed with a particular minimum amount of vertical force (Z direction).

This type of tactile dome 110 provides a target area (“sweet spot”) for the plunger protrusion 130. The sweet spot is the area that provides the maximum tactile feedback to a user when actuated. When the plunger 190 receives an external force, the tactile dome 110 can either be pressed in the vertical direction, (e.g., on the “sweet spot”) or in the direction of the force (e.g., obliquely). The tactile dome 110 collapses when it receives a predetermined amount of force on the sweet spot and snaps back when the force is removed, thus providing a crisp tactile feedback to the user.

In another embodiment (not shown), instead of establishing a protrusion 130, the tactile dome 110 is provided with a raised dimple in the center of the tactile dome 110. An advantage to a tactile dome with raised dimple is that the plunger 190 does not need to be precisely centered to collapse the tactile dome 110. Thus, a plunger with a flat bottom surface can contact the raised dimple first and push the tactile dome in the center via the raised dimple.

The joystick enables a user to navigate an onscreen cursor of the electronic device. This is achieved using a force sensing resistive layer 120. In accordance with an embodiment, the rigid retainer 105 is the component that establishes contact with the force sensing resistive layer 120 when an external force is received by the plunger 190. A convex bottom surface 150 of the rigid retainer 105, in the absence of the external force, is held slightly above the force sensing resistive layer 120 such that when a substantially vertical external force is received on the plunger 190, the bottom surface 150 of the rigid retainer resumes contact with the force sensing resistive layer. The force received by the plunger 190 is transferred to the force sensing resistive layer 120 through the rigid retainer 105. The flexible mould 115 provides upward and downward mobility for the rigid retainer 105 while maintaining a relative nominal XY position of the rigid retainer 105 over the force sensing resistive layer 120.

FIG. 2 shows an embodiment where a joystick 200 is equipped with snap locks 298 on a rigid retainer 205. The snap locks 298 are provided to hold a plunger 290 and the rigid retainer 205 together. The plunger 290 has a top surface 235 and a bottom surface 233. The bottom surface 233 of the plunger 290 has a protrusion 230 to provide force to a convex surface 245 of the tactile dome 210 when the plunger 290 is depressed with a particular minimum amount of vertical force (Z direction). The top surface 235 of the plunger 290 is designed to receive a human finger to apply an external force.

The plunger 290 is mounted orthogonal to the XY plane and coupled to the rigid retainer 205. The rigid retainer 205 holds the plunger 290 orthogonal to the XY plane and is coupled to a flexible mould 215. The flexible mould 215 is mounted on a base 225 such as a PCB in the electronic device. In one embodiment, a convex bottom surface 250 of the rigid retainer 205 makes contact with a force sensing resistive layer 220 to transmit a force received on the top surface 235 of the plunger 290 as transmitted through the plunger 290 to a bottom surface 233 having a protrusion 230. When enough downward force is put on the plunger 290, the protrusion 230 presses a tactile dome 210 that is disposed between the rigid retainer 205 and the bottom surface 233 of the plunger 290. When the “sweet spot” of the tactile dome 210 is actuated it produces a snap that results in a tactile feedback provided to the user.

While the rigid retainer 205 and the plunger 290 are essentially rigid, they are provided with enough flexibility to allow a snap together type of assembly. The plunger 290 and the rigid retainer 205 need not necessarily be made of the same material. One of them may need to provide greater flexibility to permit the snap together method. Further, it is not critical as to whether the plunger or the rigid retainer contain the snap features. Those skilled in the art shall appreciate there are other modes of holding the plunger and the rigid retainer together and such modes are within the scope of the present invention. The plunger and the rigid retainer are able to move in the Z-direction, relative to each other, so as to allow compression and subsequent snapping of the tactile dome 210 by the protrusion 230 on the bottom 233 of the plunger 290.

In another embodiment, instead of a protrusion 230 on the bottom surface of the plunger 290, the tactile dome 210 can be provided with a raised dimple in the center of the tactile dome 210. An advantage to a tactile dome with raised dimple is that the plunger 290 does not need to be precisely centered to collapse the tactile dome 210. A plunger with a flat bottom surface can contact the raised dimple first and push the tactile dome in the center via the raised dimple.

FIG. 3 shows a perspective view of a joystick 300 pursuant to an embodiment of the invention. Like the other embodiments, this joystick can be used as a navigation device for an onscreen cursor in a mobile device, PDA or laptop. It can also be used as a gaming joystick in video game consoles. The joystick 300 is mounted on a base 325 such as a PCB that establishes an XY plane and that is housed in an electronic device. A plunger 390 has a top surface 335 that contacts a finger of a user and a bottom surface 333 with a tactile dome 310 mounted upon it. The plunger 390 permits a user to navigate in 360 degrees along the XY plane. The user can move the plunger 390 in any direction in the XY plane or along the “Z” axis for purposes of activating a “select” function. Instead of 360 degrees of movement in the XY plane, the joystick can be constrained to fewer degrees of freedom, such as only along one axis in the XY plane, along two axes in the XY plane, and such. The plunger 390 can be made of any rigid modulated plastic material or a kind of polycarbonate or the like.

The plunger 390, on receiving an external force in the Z axis of at least a predetermined magnitude, presses a convex surface 345 of the tactile dome 310 against a force sensing resistive layer 320. If the external force is great enough, the tactile dome 310 collapses, which provides tactile feedback to the user. The maximum feedback is attained when the “sweet spot” of the tactile dome 310 is suppressed. The nature of the tactile dome 310 permits maximum tactile feedback when pressed along the vertical “Z” axis. Slight deviation from the vertical axis may inhibit or reduce the tactile snap of the dome and allow navigation functions using the forces sensing resistive layer 320 as will be described further. Movement of the plunger 390 in the XY plane should not, in principle, snap the tactile dome 310, since the external force applied to enable movement in the XY plane will be mainly non-vertical. Hence, force along the vertical “Z” axis permits maximum tactile feedback and can be used for a “select” function.

A flexible mould 315 holds the plunger 390 in a relatively nominal XY position over the force sensing resistive layer 320. As with all the embodiments, the flexible mould 315 can be made of silicon, an elastomer, or other suitable flexible material. The flexible mould 315 permits movement of the plunger 390 when an external force is applied. While permitting the aforementioned movement, the flexible mould 315 is responsible for maintaining the general position of the plunger 390.

FIG. 4 shows another embodiment of a joystick 400. This particular embodiment is similar to the embodiment shown in FIG. 3. A tactile dome 410 is fixed directly onto a bottom surface 433 of a plunger 490 with the help of an adhesive material or similar substances that would enable the tactile dome 410 to firmly stick to the plunger 490.

When the plunger 490 is actuated due to an external force on an upper surface 435, a convex surface 445 of the tactile dome 410 makes contact with the force sensing resistive layer 420 on a base 425 such as a PCB in an electronic device. The force sensing resistive layer 420 has a plurality of sensing elements. The tactile dome 410 transfers the external force to the force sensing resistive layer 420. The sensing elements sense the direction and the amount of force to determine the direction, movement and/or velocity of an onscreen cursor as will be described later.

In the case where the tactile dome 410 snaps due to the amount of external force in the Z direction, and the force measured at the force sensing resistive layer 420 is equal in the plurality of sensing elements, the force sensing resistive layer 420 recognizes a “select” function and selects an item indicated by an onscreen cursor position or performs an equivalent function such as “fire” on a video game.

The joystick can be implemented to perform the same functions as a mouse for use in, for example, navigating a web page. The joystick can be used to navigate the cursor on a screen to highlight a hyperlink. Then the joystick is depressed to “select” that hyperlink, which then brings up another web page. Those skilled in the art shall appreciate that the “select” function can be used for other purposes such as firing a weapon in the case of gaming systems, and these embodiments are within the scope of the present invention.

Returning to FIG. 4, the flexible mould 415 provides the mobility required for the plunger 490 to move in the upward or downward (i.e., Z axis) direction to establish contact with the force sensing resistive layer 420. While permitting the movement of the plunger 490, the flexible mould 415 maintains the general position of the plunger 490.

In another embodiment (not shown), the tactile dome can be placed on a top surface of the plunger. In this situation, the tactile dome should be enclosed in a protective cover so that the tactile dome is not directly exposed to moisture, oils from the user of the joystick, etc. The user of the joystick still experiences a tactile feedback when the tactile dome is actuated by way of an external force. In this situation, the bottom surface of the plunger (or rigid retainer) that contacts the force sensing resistive layer would be convex. Thus, the force received on the tactile dome is transferred to a plunger, which in turn transfers the force to the force sensing resistive layer either directly (as in FIG. 3 and FIG. 4) or indirectly (as in FIG. 1 and FIG. 2).

FIG. 5 provides a detailed illustration of the working of the force sensing resistive component 500. The force sensing resistive component 500 can be any of the previously described force sensing resistive layers 120, 220, 320, 420. The direction and functioning of the onscreen cursor is determined by the force sensing resistive component 500 based on the direction and amount of external force received by the sensing elements on the force sensing resistive layer 510. The force sensing resistive layer 510 includes sensing elements in a plurality of sections 522, 524, 526, 528 of the force sensing resistive layer 510. In this particular embodiment, the force sensing resistive layer 510 is divided into quadrants. Pins 591, 594, 595, and 598 lead to common traces. Pins 592, 593, 596, and 597 lead to signal lines. Measuring resistance in each quadrant 522, 524, 526, 528 from the signal lines to the common traces gives a resistance reading that is proportional to the force applied to the forces sensing resistive layer 510.

According to an embodiment, when a force is applied to a tactile joystick in an electronic device, a plunger is actuated and a bottom surface of the plunger directly or indirectly makes contact with the force sensing resistive layer 510. In one embodiment, the plunger indirectly makes contact with the force sensing resistive layer through a rigid retainer or tactile dome. In an alternative embodiment, the plunger directly makes contact with the force sensing resistive layer. Once contact is established with the force sensing resistive layer, a determination is made about a distribution of the force applied to the plunger.

In this embodiment, if a tactile dome (such as a tactile dome 110, 210, 310, 410) collapses and the distribution of the force is relatively equal in all the quadrants 522, 524, 526, 528 of the force sensing resistive layer, a select signal is sent to a processor 515, which is coupled to the force sensing resistive layer 510. Upon receiving such a select signal, the processor 515 carries out the select function.

If the applied force has an unequal distribution in the quadrants 522, 524, 526, 528 of the force sensing resistive layer 510, regardless of whether a tactile dome has collapsed, a direction signal in the direction of the force is sent to the processor 515, and the processor 515 implements the signal in the direction of the force. In this case, at least one of the sensing elements experiences a substantially greater force than the other sensing elements, thus providing an indication of the user's intention to move in that particular direction. On determining the direction of the force, the force sensing resistive layer 510, sends the direction signal to the processor 515 for execution of a cursor movement in the direction and with a velocity indicated through the force sensing resistive layer 510.

If the joystick is designed to allow 360 degree navigation in the XY plane (as well as make a “select” function by moving on the Z axis), the processor 515 is programmed to allow for such 360 degree movement. If the joystick is constrained to navigate only in four directions (e.g., up, down, left, right) and the Z axis, then the processor 515 will be programmed to interpret direction signals under this limitation. Similarly, if the joystick should only control Y axis (up and down) and Z axis movements, then the processor 515 allows the cursor to be moved only along the Y axis and trigger a select function. Other navigation options are also feasible. Note that cursor control using a single joystick can be limited differently at different times by changing the programmed mode of the processor 515 under the direction of a software program.

An embodiment includes a method of implementing a function by a joystick as shown in a flowchart 600 in FIG. 6. The method starts by first actuating a tactile dome 605 in a joystick of an electronic device such as a mobile phone, PDA, laptop or a game controller. The joystick can be one of the joysticks described earlier along with their related tactile domes 110, 210, 310, 410. An external force in a Z direction is applied to actuate the tactile dome. After activating the tactile dome, a measurement for a distribution of the force is made 610 within a force sensing resistive component of the tactile device such as shown in FIG. 5. Based on the distribution of the force in a plurality of sensing elements in the force sensing resistive layer, the function is implemented.

According to an embodiment, if the distribution of the force is relatively equal in the plurality of sensing elements in a plurality of sections in the force sensing resistive layer 620, a select signal is sent to a processor coupled to the force sensing resistive layer 625, and the processor implements the select signal 630.

Besides implementing the select function, a further embodiment navigates a cursor on a screen or display using the tactile joystick in the electronic device. With or without a snap of the tactile dome, if the force received by the quadrants of the force sensing resistive layer is unequal, a navigation signal is sent to a processor 635 of the force sensing resistive layer and the processor executes the navigation signal. The navigation signal can involve navigating a cursor in one-dimension such as scrolling up and down, along two orthogonal axes such as moving up, down, left and right, though a full 360 degrees in an XY plane, and other variations.

Another embodiment includes a flowchart 700 for implementing a “select” function using a joystick in an electronic device. The “select” function is used to make a selection on a screen of an electronic device, such as a mobile phone, laptop, PDA or a game controller. A user may wish to select an icon on the screen of a terminal when using a game controller to play a game, or may wish to select a particular item in a menu available in a display of a mobile phone. Before selecting a particular icon or item, the user typically scrolls up, down, left or right or other directions in the XY plane of the display, until the cursor comes across the icon or item of his choice.

According to the embodiment illustrated in FIG. 7, the method includes actuating a tactile dome by applying a substantially vertical force 705, determining a dome snap 710 and then implementing the select function 715. The occurrence of the dome snap is a critical event in anticipating the select function, and there are several situations under which the dome snap can be determined.

According to one embodiment, as shown in FIG. 8, the dome snap is determined by measuring a first low resistance point 805, then measuring a high resistance point 810, and lastly measuring a second low resistance point 815. In the event of a dome snap, there is a trend in the change of the resistance value with respect to the force received. An increase in force results in a decrease in resistance, and a force sensing resistive component such as that shown in FIG. 5 is able to measure and recognize this trend and accordingly implement the “select” function. In other words, when the force increases, the resistance decreases to a point 805, then the tactile dome snaps which allows the resistance to increase to point 810 and thereafter the resistance continues to decrease to point 815 with a collapsed tactile dome. This debounce trend, from point 805 to point 815, typically lasts 30 milliseconds, and depends greatly on the manufacture and implementation of the tactile dome.

According to another embodiment, as shown in FIG. 9, the dome snap can similarly be determined by measuring change in voltage. This involves measuring a first high voltage point 905, a low voltage point 910, and lastly measuring a second high voltage point 915. Since resistance is inversely proportional to voltage, when the force increases, the voltage increases to a point 905. Then the tactile dome snaps which decreases the voltage to point 910 and thereafter the voltage continues to increase to point 915 with a collapsed tactile dome. As there is a change in resistance, there is correspondingly a trend in the change of voltage, and the force sensing resistive component is capable of measuring and recognizing this trend. Again, the debounce trend, from point 905 to point 915, typically lasts 30 milliseconds, and depends greatly on the manufacture and implementation of the tactile dome.

The present invention relates to an electronic device with an integrated tactile joystick that provides a user with a crisp tactile feedback, along with onscreen cursor movement. Further, the present invention also pertains to a method of implementing a function, such as a select function, using the tactile joystick in the electronic device.

What is claimed is:

1. An electronic device with a tactile joystick comprising:
a force sensing resistive layer in an XY plane;
a flexible mould surrounding at least one portion of the force sensing resistive layer;
a plunger coupled to the flexible mould, mounted orthogonal to the XY plane; and
a tactile dome disposed adjacent to one of a top surface and a bottom surface of the plunger.

2. The electronic device of claim 1, wherein the tactile dome is capable of contacting the force sensing resistive layer to indicate a cursor movement.

3. The electronic device of claim 1, wherein a top surface of the plunger is made to receive a substantially vertical force.

4. The electronic device of claim 1, wherein a bottom surface of the plunger has a protrusion.

5. The electronic device of claim 1, further comprising:
a rigid retainer coupled to the flexible mould, mounted orthogonal to the XY plane such that an inner surface of the rigid retainer abuts a lower surface of the tactile dome on the bottom surface of the plunger.

6. The electronic device of claim 5, wherein the rigid retainer is capable of contacting the force sensing resistive layer to indicate a cursor movement.

7. The electronic device of claim 6, wherein a bottom surface of the rigid retainer is convex.

8. The electronic device of claim 1, wherein the plunger is capable of contacting the force sensing resistive layer to indicate a cursor movement.

9. The electronic device of claim 8, wherein a bottom surface of the plunger is convex.

10. A method of implementing a function using a tactile device, the method comprising steps of:
measuring a distribution of a force in a plurality of sections in a force sensing resistive layer;
navigating a cursor based on the distribution of the force in the plurality of sections;
actuating a tactile dome; and
performing a select function.

11. The method of claim 10, wherein the performing step further comprises:
executing the select function if the distribution of the force is substantially equal in the plurality of sections in the force sensing resistive layer.

12. The method of claim 10, wherein the navigating step further comprises:
executing a direction signal if the distribution of the force is substantially greater in at least one of the plurality of sections in the force sensing resistive layer.

13. The method of claim 10, further comprising:
navigating the cursor in one-dimension.

14. The method of claim 10, further comprising:
navigating the cursor in two-dimensions.

15. A method of using a tactile joystick in an electronic device, the method comprising steps of:
navigating a cursor by applying a horizontal force;
actuating a tactile dome by applying a substantially vertical force;
determining a dome snap; and,
implementing a select function.

16. The method of claim 15, wherein the determining step further comprises:
measuring a first high voltage in a plurality of sections of a force sensing resistive layer;
measuring a low voltage in the plurality of sections;
measuring a second high voltage in the plurality of sections;
sending a select signal to a processor based on the first high voltage, the low voltage and the second high voltage; and
executing a select function in response to the select signal.

17. The method of claim 15, wherein the determining step further comprises:
measuring a first low resistance in a plurality of sections of a force sensing resistive layer;
measuring a high resistance in the plurality of sections;
measuring a second low resistance in the plurality of sections;
sending a select signal to a processor based on the first low resistance, the high resistance and the second low resistance; and
executing a select function in response to the select signal.
